(19) United States
(12) Patent Application Publication
(10) Pub. No.: US 2009/0321244 A1
(43) Pub. Date: Dec. 31, 2009

(54) PROCESS FOR PRODUCING HYDROGEN

(75) Inventors: John R. Smith, Birmingham, MI (US); Thomas H. Steenkiste, Ray, MI (US); Xiao-Gang Wang, Troy, MI (US)

Correspondence Address: DOBRUSIN & THENNISCH PC, 29 W LAWRENCE ST, SUITE 210, PONTIAC, MI, 48342, US

(73) Assignee: Hydrogen Generation Inc., Birmingham, MI (US)

(21) Appl. No.: 12/490,498

(22) Filed: Jun. 24, 2009

Related U.S. Application Data
(60) Provisional application No. 61/075,462, filed on Jun. 25, 2008.

(51) Int. Cl. C01B 3/02; B01J 8/02; B01J 8/04; B01J 19/08

(52) U.S. Cl. 204/157.52; 422/211; 422/188; 422/198

(57) ABSTRACT

The present invention relates to the conversion of water into hydrogen and oxygen, and more particularly to a conversion of water into hydrogen and oxygen using sunlight and an inorganic catalyst. More specifically, the invention relates to systems and processes for generating hydrogen molecules from sunlight and water, such as a process comprising the steps of: i) contacting the water with nanoparticles of an inorganic photocatalyst compound in a reaction zone of a reaction chamber; ii) concentrating sunlight with an optical intensifier such that the intensity is increased by a factor greater than 2; iii) heating the reaction zone to one or more reaction temperatures greater than 140° C. using the concentrated sunlight; and iv) exposing water in the heated reaction zone and in the presence of the inorganic photocatalyst compound, while at the one or more reaction temperatures, to the concentrated sunlight so that a reaction occurs that generates hydrogen molecules from the water; wherein the photocatalyst includes an element selected from Cu, Al, Ti, Ga, Cd, Zn, W, Fe, Sn, Si, or any combination thereof, the water is in the form of water vapor, the step of heating the reaction zone includes a step of converting the sun light into thermal energy, the reaction zone is free of any electrode for a photoelectrochemical process; and wherein the photocatalyst is characterized by one of the following: (1) the nanoparticles are calcined nanoparticles; (2) the nanoparticles includes an element selected from Cu, Al, Ti, Ga, Cd, Zn, W, Fe, Sn, Si, or any combination thereof; or (3) both (1) and (2).

### CLAIM OF PRIORITY

This application claims the benefit of the filing date of U.S. Provisional Application No. 61/075,462 filed on Jun. 25, 2008, hereby incorporated by reference.

### FIELD OF THE INVENTION

The present invention relates to the conversion of water into hydrogen and oxygen, and more particularly to a conversion of water into hydrogen and oxygen using sunlight and an inorganic catalyst.

### BACKGROUND OF THE INVENTION

Societal demand for energy is growing. With the demand, there has been a surge in the search for alternative energy sources other than those based on fossil fuels. For example, there has been an ongoing effort to improve processes for the generation of hydrogen gas for fuel cells. A large source of renewable energy is the sun. It has been estimated that a solar energy “farm” covering about 0.4% of the land area of the continental United States, operating at an efficiency of 40%, and located at a typical latitude could meet the entire energy needs of the United States (Lewis, N. S., and Crabtree, G., “Basic Research Needs for Solar Energy Utilization: Report of the Basic Energy Sciences Workshop on Solar Energy Utilization, Apr. 18-21, 2005”, United States Office of Science—U.S. Department of Energy, available at http://www.sc.doe.gov/bes/reports/files/SEU_rpt.pdf). One method of capturing solar energy is to use the energy of sun light to react a molecule having a high concentration of hydrogen (e.g. water) to form hydrogen gas. The hydrogen gas can then be stored until it is needed and later converted into another form of energy such as thermal, mechanical, or electrical energy. Hydrogen gas storage of solar energy allows for an energy supply, even during times when solar energy is not available, (such as during the night and during times of cloud coverage.) An approach to the photocatalytic generation of hydrogen is described by Smith et al. (US Patent Application Publication 2007/0196268 A1, incorporated herein by reference).

The use of polysulfide or S²⁻ with the delafossite CuAlO₂ to photocatalytically generate hydrogen gas is discussed by N. Koriche, A. Bouguelia, A. Aider, and M. Trari, “Photocatalytic Hydrogen Evolution over Delafossite CuAlO₂”, International Journal of Hydrogen Energy, vol. 30 (2005), 693-699). Koriche et al. performed their experiments at about 48° C. and measured the hydrogen gas concentration every 10 minutes. They observed that the rate of hydrogen gas generation decreased by over 50% within the first 20 to 60 minutes of each experiment.

Agrafiotis et al. (C. Agrafiotis, M. Roeb, A. G. Konstandopoulos, L. Nalbandian, V. Zaspalis, C. Sattler, P. Strobbe, and A. M. Steele, “Solar Water Splitting for Hydrogen Production with Monolithic Reactors”, Solar Energy, vol. 79, 2005, 409-421) discuss the possibility of generating hydrogen gas at temperatures greater than about 800° C. using a two step process: active redox reagent powders to generate hydrogen, followed by a regeneration step in which oxygen is released from the powders.

Methods for generating hydrogen include those described in U.S. Pat. No. 5,973,825 (J. B. Lasich, issued Oct. 26, 1999, that describes a process for separating solar radiation into short wave radiation directed to a solar cell and long wave radiation directed to heat water for high temperature electrolysis), and U.S. Patent Application Publication Nos. 2006/0188433 A1 (Weimer et al., published on Aug. 24, 2006, that describes methods for the generation of hydrogen via water splitting using a high temperature solar aerosol reactor that includes specific metal oxide) 2008/0299697 (Guerra et. al., published on Dec. 4, 2008 describes the use of titania compounds, and particularly stress-induced bandgap-shifted titania photocatalytic surface for the photoelectrolytic production of hydrogen gas from water), all of which are expressly incorporated herein by reference.

As stated by Brad Plummer (Brad Plummer, SLAC Today, publication of the Stanford Linear Accelerator Center, Aug. 10, 2006), there is a need for catalysts which 1) are a good solar absorber, and 2) do not corrode (i.e. are stable in water).

The use of solar concentrators in photochemical or photoelectrochemical cells to concentrate the incident solar energy by the use of mirrors (and thereby increase the flux of the solar energy) is described by Radhakrishnan et al. (U.S. Patent Application Publication No. US 2007/0148084). Examples of solar concentrators include parabolic trough solar concentrators, such as those described in National Renewable Energy Laboratory Subcontract Report: NREL/SR-550-32282, “Parabolic Trough Concentrators: Wind Tunnel Test of Parabolic Trough Solar Collectors”, by Hosoya, N., Peterka, J. A., Gee, R. C., and Kearney, D., May, 2008, which may be employed to capture the thermal component of solar energy to generate steam, and/or convert steam to electricity.

All of the fore mentioned U.S. patents and U.S. patent applications are expressly incorporated herein by reference.

There continue to be many needs in this field, including a need for photocatalysts which have a long useful life and produce hydrogen more efficiently; for photocatalyst processes which are more efficient at converting solar energy into energy stored as hydrogen gas, thermal energy, and the like (particularly including combinations), and for photocatalytic devices which are more economical.

### SUMMARY OF THE INVENTION

One or more of the above needs are met by the various aspects of the present invention. By way of illustration, one aspect of the present invention is directed at a process for generating hydrogen molecules from water comprising the steps of: i) contacting the water with nanoparticles of an inorganic photocatalyst compound in a reaction zone of a reaction chamber; ii) concentrating sunlight with an optical intensifier such that the intensity is increased by a factor greater than 2; iii) heating the reaction zone to one or more reaction temperatures greater than 140° C. using the concentrated sunlight; and iv) exposing water in the heated reaction zone and in the presence of the inorganic photocatalyst compound, while at the one or more reaction temperatures, to the concentrated sunlight so that a reaction occurs that generates hydrogen molecules from the water; wherein the photocatalyst includes an element selected from Cu, Al, Ti, Ga, Cd, Zn, W, Fe, Sn, Si, or any combination thereof, the water is in the form of water vapor, the step of heating the reaction zone includes a step of converting the sun light into thermal energy, the reaction zone is free of any electrode for a photoelectrochemical process; and wherein the photocatalyst is characterized by one of the following: (1) the nanoparticles are calcined nanoparticles; (2) the nanoparticles includes an element selected from Cu, Al, Ti, Ga, Cd, Zn, W, Fe, Sn, Si, or any combination thereof; or (3) both (1) and (2).

The process for generating hydrogen molecules may further be characterized by one or any combination of the following: the reaction zone is substantially free of sulfur containing compounds and any organic compounds; the photocatalyst includes a compound selected from CuAlO₂, TiO₂, CuO, Cu₂O, NiO, GaAs, GaP, CdSe, ZnO, WO₃, Fe₂O₃, SnO₃, SiC, CuGaO₂, and CulnO₂ or any combination thereof; the photocatalyst comprises nanoparticles having an average BET surface area greater than about 2 m²/g; the photocatalyst comprises CuₓAl_{y}O_{z}, wherein x ranges from about 0.95 to about 1.05, y ranges from about 0.95 to about 1.05, x+y ranges from about 1.95 to about 2.05 and z ranges from about x+y−0.05 to about x+y+0.05; the photocatalyst is prepared by a calcination process comprising a plurality of steps of heating a photocatalyst feedstock consisting essentially of either the CuAlO₂, or a mixture of CuO and Al2O3, to increasing temperatures; wherein the plurality of steps includes a step of heating the photocatalyst feedstock to a first calcination temperature from about 800° C. to about 1080° C. for a first calcination time of at least 2 hours, and a latter step of heating the photocatalyst feedstock to a calcination temperature of at least about 1155° C. for a calcination time of at least 2 hours; the calcination process includes at least four steps of heating the photocatalyst feedstock to increasing temperatures; the process includes one or more reaction temperatures from about 210° C. to about 550° C.; the process further comprises steps of separating the hydrogen and oxygen molecules from the water, and wherein the reaction zone has a pressure of from about 1.5 atmospheres to about 30 atmospheres; the process further comprises a step of removing heat; the process further includes a step of removing the hydrogen molecules from the reaction zone, wherein the step of removing the hydrogen molecules from the reaction vessel includes a step of continuously flowing water, liquid, vapor or both, into the reaction zone, through the reaction zone and out of the reaction zone; the sunlight comprises ultraviolet light, visible light, and infrared light; the reaction requires the ultraviolet light, the visible light, or both; the step of heating the water molecules includes a step of converting sunlight into thermal energy; the reaction zone is at least partially contained within a material (e.g., a reaction chamber) that is transparent to solar radiation; the reaction zone includes a fluidized bed containing the photocatalyst particles; the photocatalyst particles are suspended by a continuous gas flow; the reaction zone includes a fixed bed containing the photocatalyst particles; the fixed bed comprises a transparent monolith formed to contain open inner channels for gas flow through the monolith; the photocatalyst is attached to one or more of the inner channels; the material of the monolith is at least partially transparent to the ultra violet and visible parts of the solar spectrum; the monolith material at least partially absorbs the infrared part of the solar spectrum so that it is heated; the process is further characterized by an efficiency of converting light energy into chemical energy which is greater than about 1% (e.g., greater than about 10%); or the process has an efficiency for converting solar energy into hydrogen molecules, wherein the efficiency decreases by less than 10% after the photocatalyst is used for photocatalytically generating hydrogen molecules at a temperature of about 210° C. for a cumulative time of about 200 hours.

Another aspect of the invention is an apparatus for photochemically generating hydrogen water (e.g., for use in a process described above or taught herein), comprising: i) one or more reaction vessels, wherein each reaction vessel includes one or more channels for reacting the water with sunlight, wherein each channel has an entrance end and an exit end for flowing water, in the form of liquid, gas, or both, through the channel, and the reaction vessel is formed of a material that is substantially transparent to visible and ultraviolet light; and ii) a photocatalyst attached to a surface located within an interior surface of the reaction vessel; wherein the reaction vessel is free of any electrode for an electrochemical reaction.

The apparatus may be further characterized by one or any combination of the following: the reaction vessel includes a monolithic structure having a plurality of channels; the photocatalyst is attached to an interior surface of the reaction vessel; the reaction vessel includes a wall of the reaction vessel that includes quartz; the photocatalyst includes an element selected from Cu, Al, Ti, Ga, Cd, Zn, W, Fe, Sn, Si, or any combination thereof; the photocatalyst comprises CuₓAl_{y}O_{z}, wherein x ranges from about 0.95 to about 1.05, y ranges from about 0.95 to about 1.05, x+y ranges from about 1.95 to about 2.05 and z ranges from about x+y−0.05 to about x+y+0.05; or the plurality of reaction chambers includes a bundle of tubes (e.g., quartz tubes).

Another aspect of the invention is a system for generating hydrogen molecules from sunlight and water in a reaction zone (e.g., a system for use in a process described above, or taught herein), comprising i) a reaction chamber including a reaction zone; ii) at least one optical intensifier that is in optical communication with the reaction zone and that heats the reaction zone to a temperature greater than 140° C.; and iii) nanoparticles of an inorganic photocatalyst compound; wherein the reaction chamber holds water and the nanoparticles, such that at least some of the nanoparticles contacts the water; the optical intensifier increases the intensity of sunlight by a factor greater than about 2; the reaction zone is free of any electrode for a photelectrochemical process; and wherein the system is further characterized by one of the following: (1) the nanoparticles are calcined nanoparticles; (2) the photocatalyst includes an element selected from Cu, Al, Ti, Ga, Cd, Zn, W, Fe, Sn, Si, or any combination thereof; or (3) both (1) and (2); such that a reaction occurs that generates hydrogen molecules from the water.

### BRIEF DESCRIPTION OF THE DRAWING

FIG. 1 is a schematic diagram of one illustrative hydrogen gas generation system in accordance with the present invention.

FIG. 2 is a drawing of a hydrogen gas generation system using a fluidized-bed reactor.

FIG. 3 illustrates a system for generating hydrogen including an array of solar concentrators (e.g., parabolic solar concentrators) that focus the light to a reaction zone containing the photocatalyst.

FIG. 4 illustrates a perspective view of a bundle of hollow tubes that may be used for a photacatalytic reaction.

FIG. 5 is an Arrhenius plot of In R versus 1/kT, where R is the hydrogen gas generation rate of a chamber in units of ppm/hour, kT is in units of eV, and T is the temperature of the water.

### DETAILED DESCRIPTION OF THE INVENTION

The present invention is predicated upon the unexpected realization of a substantially improved process and system for generating hydrogen gas from water, particularly according to a photocatalytic process (e.g., a process that is not a photoelectocatalytic process). Though the theory or exact mechanism is not necessarily known, and there is no intention to be bound by any particular theory, it is believed that one or more of the benefits herein are realized by the ability to manage a photocatalytic reaction by i) the selection and/or preparation of specific catalysts (e.g. inorganic catalysts which may be nanoparticles, and particularly liquid or steam suspended nanoparticles, such as nanoparticles bathed in liquid water or steam), ii) the maintenance of specific conditions in a reaction zone of a reaction system; or both i) and ii). One aspect of the present invention is directed at an improved process for generating hydrogen molecules from water using a photocatalytic process. Another aspect of the invention is directed at an improved system for generating hydrogen molecules which includes a reaction zone.

Among the advantages of the technology are that no electrodes, applied fields, ion or electron currents or intrinsic charge carrier densities are required in the water or particles in order to effect the thermal activation of the photocatalytic generation of the hydrogen, and the systems may be free of one or any combination of such features. It should be realized, however, the invention contemplates the optional use of such features.

As will be gleaned from a review of the present teachings, the process and systems contemplate that one or more photocatalytic reactions take place, preferably within a reaction zone. The reaction zone typically will comprise a reaction vessel or a designated region of the vessel, e.g. a cell within a reaction vessel. The reaction zone may be in an enclosed container having an interior wall surface, the reactants or other items contained within the wall surface or both, will be free of reaction contaminants as will be discussed. Moreover, it may also be preferred that the catalytic reaction takes place at a relatively high temperature. Preferably, the reaction zone is maintained so that the water therein is higher than 60° C., and more preferably higher than 140° C. The reaction zone may exhaust into a larger volume, and there may be a return path from the larger volume to form a closed loop system, as described below. The inorganic catalyst compound preferably is in the form of particles which are sufficiently small to be characterized as nanoparticles (e.g., they have an average diameter less than about 100 nm, and more preferably less than about 50 nm), and more specifically they are nanoparticles processed by calcination. Heated water (optionally preheated, such as by a secondary heat source) in the presence of the catalyst compound is exposed to a light source (e.g. sunlight) and a reaction occurs which generates hydrogen molecules from the water.

The reaction vessel may contain one or more reaction zones. If the reaction vessel contains multiple reaction zones, they may be located in one or more shared reaction chambers (e.g. a reaction cell) of the reaction vessel, they may be located in reaction chambers that are interconnected (e.g. a first chamber upstream of, but in fluid communication with a second chamber), or they may even be in separate, unconnected reaction chambers.

The water and the catalyst in the reaction zone may be present in any form. According to the present invention, the water and the catalyst may form a suspension (e.g. a slurry), in which the catalyst particles are suspended in the water. Catalyst particles may be allowed to separate from the liquid. However, more preferably, the particles are substantially continuously suspended (e.g., bathed with water or steam) for one or more predetermined amounts of time (e.g. throughout the reaction, at the start of the reaction only, intermittently throughout the reaction). Such continuous suspension (e.g., bathing) may be maintained by any means, such as chemical, physical (e.g. agitation), or otherwise. A reaction chamber (e.g. a cavity in a suitable housing) may have one or more appendages protruding from the wall of the chamber towards the interior of the chamber. For examples, such appendages may be posts, rods, screens, baffles, or other structure and may be fixed or moving. In particular, an appendage may provide a stirring or mixing function. Such appendages, if present, may even be coated with the catalyst material. Physical agitation may also be provided by a suitable mechanism (e.g. a magnetic stirring rod) which is located inside the reaction chamber (such a mechanism may also be coated with the catalyst). Physical agitation may also be provided by the convection of the water or steam, or by a phase change (e.g. boiling of the water). The catalyst may be treated or otherwise modified to reduce or eliminate agglomeration, particularly to avoid any deleterious agglomeration prior to the reaction, during the reaction, and/or following the reaction. The water may be present in the form of a gas. In such a case, the catalyst particles may be suspended in the gas. As one example, the gas and catalyst particles may form a fluidized bed. The catalyst may also be on a substrate, in the form of particles, film or otherwise. For example, the catalyst may be in a fixed position, particularly in a fixed position which maximizes the contact with water, light, or both.

Catalyst particles which are on a substrate may be supported on a substrate having a high surface area. For example, the substrate may be a porous ceramic and the catalyst particles may be deposited via a wash coat process. If the substrate is porous, the pores are preferably such that water (liquid or vapor) could traverse them, allowing water contact with the catalyst particles within the pores. In this case, the photocatalytic splitting of water may require that the solar radiation penetrates into the pores to interact with the catalyst particles and water. This may be achieved by using a catalyst support which is transparent or partially transparent to the solar radiation spectrum.

Preferably, the reaction zone (or the reaction chamber, or even the reaction vessel or the entire reaction system) is substantially free of chemicals which could degrade, poison, or otherwise reduce the efficiency of the catalyst or otherwise compromise the efficiency of the catalytic reaction. For example, organic compounds such as lubricants and greases may coat the catalyst surface or otherwise cause the catalyst surface to become inactive. Some inorganic compounds, such as sulfur containing compounds, may also deleteriously affect the catalyst. As such, it is preferable that the reaction zone, the reaction chamber, the reaction vessel, or even the reaction system, is substantially free (or even totally free) of sulfur containing compounds and any organic compounds, (e.g. organic compounds having a molecular weight below about 20,000, preferably below about 2,000). It may be possible to use some high molecular weight organic compounds, such as polymeric materials, within the vessel provided they have little or no solubility in the water, are not in direct contact of the catalyst material, and do not decompose at the reaction temperature for generating the hydrogen gas. It may also be possible to use very low molecular weight organic compounds which have a low boiling temperature (e.g. less than about 60° C.), do not form a strong bond (e.g. ionic, covalent, or hydrogen bond) to the catalyst, or both.

In order to generate hydrogen gas at a desired minimum rate, it is desirable that the photocatalytic reaction occurs at an elevated reaction temperature and that the hydroxyl groups (i.e., the OH groups) adsorbed on the catalyst surface be photoexcited by the sun light. Such excited hydroxy groups are denoted as (OH)*. Without being bound by theory, it is believed that the rate of hydrogen generation, R, increases exponentially with temperature (see for example Wang, X.-G. and Smith, J. R., “Hydrogen and Carbon Effects on Al2O3 Surface Phases and Metal Deposition”, Phys. Rev. B 70, 081401(R), 2004) as given in the equation:

R=(v₀/2)β(I)N_{H}exp(−E_{D}/kT), (equation 1)

where v₀ is the (OH)* vibrational frequency (approximately 1.12×10¹⁴/sec for ground state OH in pure water), β=β(I)=fraction of the resident OH hydroxyl groups of number N_{H} on the catalyst surface that are photoexcited, i.e., in the state (OH)*, E_{D} is the activation energy for desorbing a hydrogen atom in the presence of the light, k is Boltzmann's constant and T is the temperature in Kelvin. β is a function of the solar intensity I, and its steady state value derives from a competition between the light (e.g., solar light) induced excitation rate and the (OH)* deexcitation rate, where the deexcitation rate may be due to electron-hole recombination.

The reaction zone may be heated by any means. For example, the reaction zone may be heated by sunlight, by a heating device, by a thermal reservoir in which heat has been stored, or any combination thereof. The means of heating may change. For example, when the reaction zone temperature is relatively low (e.g., below about 100° C.), the light intensity is relatively low (e.g., a direct irradiance of less than about 60 W/m²), or both, it may be necessary to supplement any heat that may be generated by the light with heat from a heating device (e.g. a resistance heater, a gas heater, or the like) or from a thermal reservoir (which may employ phase change materials). The reaction vessel system (e.g. the reaction vessel) may be insulated or otherwise adapted to help minimize the loss of heat from the reaction zone.

The reaction temperature may be constant, but possibly will vary over time. For example, the reaction temperature may vary throughout the day, increasing when the intensity of the light (e.g. sun light) is high and decreasing when the intensity of the light is low. The process may include a reaction temperature which is greater than about 60° C., preferably greater than about 101° C., more preferably greater than about 140° C., and most preferably greater than 200° C. (e.g. greater than about 210° or even greater than about 255° C.). With respect to optimizing the hydrogen gas generation rate, it is possible that there is no maximum reaction temperature. However, the maximum reaction temperature is preferably less than about 750° C., more preferably less than about 550° C., and most preferably, less than about 500° C. (e.g. the maximum reaction temperature may be less than 400° C.).

The reaction temperature derives from a balance between the input energy to the reaction cell and the energy losses from the cell. The input energy may include, or consist essentially of heat from solar radiation. As previously described other sources of heat may be employed. The output energy will include hydrogen and oxygen gases produced in the cell and bled off to holding tanks. Each gaseous H₂ molecule produced can liberate a heat of formation ε≅2.96 eV by interaction with oxygen to form liquid water _H₂(g)_{—}+1/2/O₂(g)=H₂O(I). Other output energy may include conductive heat and convective heat. For a given rate of input energy due to solar radiation or otherwise, the temperature will increase or decrease until the rate of energy output equals the rate of energy input (i.e., a steady-state reaction temperature may be obtained).

Any light source may be employed to provide the light for generating the hydrogen gas. Sunlight is a particularly suitable light source as it contains infrared light which may be used to heat the water and it also contains ultraviolet light and visible light which may be used to photocatalytically generate the hydrogen gas. The ultraviolet light and visible light may also heat the water, directly or indirectly (for example through a decay process involving the catalyst). Sunlight may be diffuse light, direct light or both. The light may be filtered or unfiltered, modulated or unmodulated, attenuated or unattenuated. Preferably, the light is concentrated to increase the intensity using an optical intensification system. The optical intensification system may use one or more intensifiers that include any combination of lenses, mirrors, waveguides, or other optical means, to increase the intensity of light. The increase in the intensity of the light may be characterized by the intensity of the light having from about 300 to about 1500 nm (e.g., from about 300 nm to about 800 nm) in wavelength. The optical intensification system may increase the intensity of the light by any factor, preferably by a factor greater than about 2, more preferably a factor greater than about 10, and most preferably a factor greater than about 25 (e.g. a factor greater than about 50). A non-limiting example of an optical intensification system is described in US Patent Application Publication Number 2007/0148084 A1.

As appreciated from the above, another important component of the invention is a catalyst. The catalyst may function to increase the kinetics of the hydrogen generation. In particular, the catalyst preferably is selected so that it functions to increase the kinetics of the hydrogen generation from water in the presence of light as compared with a reaction zone which is free of catalyst. It is desired that the catalyst performs such that at least 3%, preferably at least 11% and more preferably at least about 17% of the energy from the light (e.g. the light having a wavelength from about 300 nm to about 800 nm) is converted into hydrogen gas energy as determined by multiplying the number of hydrogen gas molecules generated by the 2.96 eV released by combining gaseous hydrogen and oxygen to form liquid water during a one hour test and dividing by the amount of light energy which entered the reaction zone during the one hour test, using a predetermined reaction temperature from about 140° C. to about 600° C.

The catalyst preferably contains an inorganic compound which is a solid material at the reaction temperature. The catalyst may be configured or provided to have any suitable solid form, such as a film, a coating, a porous structure, a particulate structure, and the like. One preferred structure is a particulate structure where the particles are small and can form a slurry with the water molecules. In one highly preferred embodiment, the particles include or consist essentially of nanoparticles.

As used herein, the term nanoparticles, refers to a particle having an average diameter (on a number weighted basis) of less than about 100 nm. These nanoparticles may be spherical or close to spherical in shape. Nanoparticles which are in the form of nanowires, nanotubes, or irregular shaped particles may also be used. If the particles do not have a spherical shape, the size of the particles can be characterized by the diameter of a generally corresponding sphere having the same total volume as the particle. Preferably, the nanoparticles have an average diameter of less than about 50 nm, more preferably less than about 20 nm.

The concentration of the catalyst may be such that most of the light that enters the reaction cell (or the reaction zone) does not pass through without interacting (e.g. reflection, refraction, absorption) with the catalyst. The fraction of the light, particularly the light having a wavelength from about 300 nm to about 800 nm), that passes through the reaction zone (or reaches a wall of the reaction cell) without first interacting with the catalyst preferably is less than about 20%, more preferably less than about 3%, and most preferably less than about 1%.

If the catalyst is present as particles (e.g. nanoparticles), the concentration of the catalyst should be such that the total projected area of all particles, Aₚ, as estimated by:

Aₚ=Nπ(d/2)² (equation 2)

where N is the number of particles, and d is the average diameter of the particles, is greater than the cross sectional area, A_{c}, of the chamber of the reaction vessel as defined by the largest area of the intersection of the chamber with any plane perpendicular to the direction of travel of the incident light (i.e. Aₚ>A_{c}). More preferably, Aₚ≧2A_{c}.

A reaction chamber according to the present invention may be surrounded by a solar reflector. Such a reflector may be configured for allowing the solar radiation to enter the reaction chamber from all directions or certain pre-selected directions. The solar reflector preferably will cause the solar radiation to enter the reaction chamber from a substantial range of angles in addition to the direction of the incident solar beam. In another aspect of the invention, the reaction chamber may have at least one side which allows light to enter the reaction chamber and at least one side which does not allow light to enter the reaction chamber. In this aspect of the invention, a side that does not allow light to enter the chamber may contain an interior reflective surface such that the majority of the light inside of the container which reaches the surface is reflected back into the container. In both of these aspects of the invention, the area of the catalyst which is exposed to the light may be increased and therefore the concentration of active catalyst sites may be increased. The active catalyst area may be greater than about 2, 5, 10, 20 or even 100 times the cross-sectional area of the reaction zone perpendicular to the incident light. Preferably at least 20%, more preferably at least 50% of the catalyst surface area will be active (i.e. exposed to the light), and thus takes advantage of the high surface area to volume ratio of the nanoparticle sized catalyst.

Without being bound by theory, it is desirable for the catalyst to be characterized as having a low direct band gap (i.e. the energy difference between the bottom of the conduction band and the top of the valence band should be low), such that a significant portion of the solar radiation can be absorbed across the band gap. The catalyst compounds which may be used in the present invention are inorganic compounds which have a direct band gap less than about 3.4 eV, preferably less than about 3.1 eV, more preferably less than about 2.6 eV, and even more preferably less than about 2.2 eV. Without limitation, the catalyst compounds which may be used in the present invention are inorganic compounds which have a direct band gap greater than about 0.2 eV, preferably greater than about 0.6 eV, and more preferably greater than about 0.8 eV.

A catalyst compound according to the present invention may be suitably prepared. Preferably, it is prepared by a process that includes one or more calcination steps. The calcination may be used, for example in preparing a catalyst containing two or more metals. In particular, two or more metal oxides may be mixed to form a metal oxide containing all of the metals. During calcination, oxygen may be removed from the metal oxides. In another example, a single metal oxide may be calcined to reduce the oxygen concentration. Typically at least 2% of the oxygen atoms are removed from the metal oxide or metal oxides during the calcination, based on the total number of oxygen atoms in the metal oxide or metal oxides before starting the calcination process. Preferably the calcination removes at least 5% of the oxygen atoms, more preferably at least 10% of the oxygen atoms, and most preferably at least 18% of the oxygen atoms. The calcination may have one step of heating the catalyst feedstock to a first calcination temperature from about 700° C. to about 1080° C. for a first calcination time of at least about 2 hours, and a subsequent step of heating the catalyst feedstock to a subsequent calcination temperature of at least about 1155° C. for a calcination time of at least about 2 hours. The calcination process may contain two, three, four, five, six, seven, or even more sequential and discrete steps of heating the catalyst feedstock to increasing temperatures. For example, the calcination may include, or consist essentially of the following steps:

a step of heating the material to a first calcination temperature from about 700° C. to about 1080° C. (e.g. about 800° C.) for a first calcination time of at least about 2 hours (e.g. 12 hours);

a step of heating the material to a second calcination temperature higher than the first calcination temperature (e.g. about 1000° C.) for a second calcination time (e.g. about 24 hours);

a step of heating the material to a third calcination temperature (e.g. about 1100° C.) which is higher than the second calcination temperature for a third calcination time (e.g. about 24 hours);

a step of heating the material to a fourth calcination temperature (e.g. about 1150° C.) which is higher than the third calcination temperature for a fourth calcination time (e.g. about 48 hours);

a step of heating the material to a fifth calcination temperature of at least 1155° C. (e.g. about 1160° C.) which is higher than the fourth calcination temperature for a fifth calcination time of at least 2 hours (e.g. about 24 hours). After the final heating step, the catalyst may be quenched to room temperature (e.g. using liquid nitrogen) and then ground into nanoparticles.

Fewer than all of the above steps may be employed in the calcination.

Preferably, the calcination includes one or more steps of grinding (such as by a ball mill, a hammer mill, a jet mill, a mortar and pestle, a Wiley mill, a SAG mill, and the like) the catalyst compound between at least one (more preferably between each) of the heating steps. The catalyst may also be ground after the calcination is completed. In one aspect of the invention, it is preferred that the CuAlO₂ is not prepared by a sol-gel process.

The catalyst compounds may include a binary compound, a ternary compound, or a quaternary compound, or any mixture thereof. Suitable catalyst compounds include oxides, phosphides, arsenides, selenides, carbides, or any combination thereof. Preferably the catalyst compound includes, or consists essentially of, one or more oxides.

A catalyst of the present invention may include an element selected from Cu, Al, Ti, Ga, Cd, Zn, W, Fe, Sn, Si, In or any combination thereof. Exemplary catalyst compounds include, without limitation, CuAlO₂, TiO₂, CuO, Cu₂O, NiO, GaAs, GaP, CdSe, ZnO, WO₃, Fe₂O₃, SnO₃, SiC, CuGaO₂, and CulnO₂ or any combination thereof.

Morelli et al. (U.S. Patent Application Publication No. 2005/0100100 A1, expressly incorporated herein by reference) give examples of tetrahedrally bonded compounds which may be used in the present invention. In particular Morelli et al. (paragraphs 0022-0025) show examples of oxides which contain two metals, a first metal capable of achieving a stable 1⁺ charge (such as atoms from the 1B column of the periodic table, including copper, silver, gold) and a second metal capable of achieving a stable 3⁺ charge state. Thus the catalyst of the present invention may be represented by the formula [A][B]O₂, wherein: [A] is Cu, Ag, Au or any other metal ion that can achieve a 1⁺ charge state; and [B] is Ga, In, Al, Cr, Fe, Co, Rh, Sc, Y, a lanthanide ion or any other metal ion that can achieve a 3⁺ charge state.

As one embodiment of the current invention does not employ a galvanic cell, the catalyst may include a tetrahedrally bonded catalysts as described above or a catalyst that may corrode in a galvanic cell containing water, such as AlₓGa₁₋ₓAs, GaP, CdSe, SiC, WO₃, TiO₂, Fe₂O₃, or any combination thereof.

The catalyst compound may also be doped with one or more atoms, such that the direct band gap is reduced. For example the catalyst compound may be doped with carbon, oxygen, phosphorus, nitrogen, or any combination thereof.

As described by Iwase et al. (A. Iwase, H. Kato and A. Kudo, “Nanosized Au particles as an efficient co catalyst for photocatalytic overall water splitting”, Catalysis Letters, 108:1-2, 2006, p. 7-10), the reaction system may further employ one or more co-catalysts, which may even be nanosized Au particles.

The catalyst may be a catalyst comprising copper, oxygen, and at least one metal selected from the group consisting of Al, Ga, and In, having a direct band gap less than about 3.3 eV (preferably a direct band gap from about 1.7 to about 3.3 eV). For example, the catalyst compound may have a direct band gap of about 2.9 eV to about 3.3 eV and an indirect band gap of about 1.7 eV to about 2.1 eV. In particular, CuAlO₂, may be used which has direct band gap of about 3.1 eV and an indirect band gap of about 1.9 eV. Other delafossites, such as CuGaO₂ and CulnO₂, having similar or even lower band gaps may also be employed.

As an example, the catalyst may include copper aluminum oxide, CuAlO₂. The copper aluminum oxide may be prepared by the calcination process described above. For example, the calcination process may include a plurality of steps of heating a catalyst feedstock consisting essentially of either the CuAlO₂, or a mixture of CuO and Al₂O₃, to increasing temperatures. The calcination process for CuAlO₂ may have one step of heating the CuAlO₂ catalyst feedstock to a first calcination temperature from about 700° C. to about 1080° C. for a first calcination time of at least about 2 hours, and a subsequent step of heating the CuAlO₂ catalyst feedstock to a subsequent calcination temperature of at least about 1155° C. for a calcination time of at least about 2 hours.

If CuO and Al₂O₃ are used as the feedstock for the catalyst, they should be present at a weight ratio of CuO:Al₂O₃₋ from about 40:60 to about 44:56. The resulting catalyst compound may be characterized by the following formula:

CuₓAl_{y}O_{Z},

where x may range from about 0.95 to about 1.05, y may range from about 0.95 to about 1.05, x+y may range from about 1.95 to about 2.05 and z may range from about x+y−0.05 to about x+y+0.05 (more preferably x may range from about 0.99 to about 1.01, y may range from about 0.99 to about 1.01, x+y may range from about 1.99 to about 2.01 and z may range from about x+y−0.01 to about x+y+0.01).

The copper aluminum oxide compound may be doped with one or more additional atoms, such as carbon, phosphorous, and nitrogen. If employed, the concentration of any dopant atom may be less than about 2% by weight, preferably less than about 1% by weight, based on the total weight of the catalyst compound.

One essential component of a process for generating hydrogen is a source of hydrogen atoms. Water is an abundant, economical source of hydrogen atoms. Starting materials may include water or a material that liberates water. The water used in the process is preferably processed, using a purification step, to remove impurities. Such a purification step may include at least one or more of the following steps: a step of removing ions (deionization), a filtering step, a reverse osmosis separating step which employs a semipermiable membrane, or any combination thereof.

The water may be provided as a solid, but is typically provided as a liquid or gas. If the water molecules are provided only as a gas, it may be mixed with one or more other gases. Such a gas mixture may contain any concentration of water molecules. The concentration of the water molecules in the gas may be greater than 20 mole percent, preferably greater than 50 mole percent, more preferably greater than 90 mole percent and most preferably greater than 99 mole percent based on the total moles of the gas. The gas may even consist essentially of water molecules.

The process for generating hydrogen may also include a step of regulating the pressure in the reaction zone, so that the pressure does not exceed a maximum threshold value which may be based on design or safety criteria. For a contained reaction zone, the pressure in the reaction zone will also be the pressure in the reaction cell. For a reaction system which contains a circulating fluid, such as a flow-through, fluidized bed or a fixed bed reaction zone, the pressure in the reaction zone will typically be higher than some other parts of the reaction cell.

As the reaction temperature increases, the equilibrium pressure between liquid water and water vapor increases rapidly. For example, the equilibrium pressure may be over 100 atmospheres (e.g., at a temperature of about 312° C.). There may be design, cost, safety and other considerations which limit the pressure of the system. In order to accommodate high reaction temperatures, it may be necessary for the water to only be in the vapor state when the system is at elevated temperatures (this can be accomplished, for example, by initially having a very low concentration of water in the reaction cell when it is near room temperature). Even in the vapor state, the water may still interact with the catalyst material to generate hydrogen gas. The reaction zone may be connected to an exhaust container which may be larger than the reaction vessel, with reactants free to flow from the reaction zone to the exhaust container. The exhaust container may be a separator where at least some of the H₂ and O₂ gas components are removed from the remaining gases, which may include unreacted water (or water vapor), air, and inert gases. The exhaust container may be unheated, and should be of sufficient size to restrain gas pressures to within workable limits (as discussed below), given the heating of the reaction zone and the increase in gas molecules when water is converted into hydrogen and gas molecules. It may be possible to employ a step of removing heat from the exhaust container. Depending on the intensity of the sunlight, it may also be possible to employ a step of removing heat from the reaction vessel, possibly even to prevent the reaction vessel from exceeding a maximum reaction temperature. This step of removing heat could be followed by steps of storing some of the removed heat and returning some of the stored heat to the reaction vessel. These steps could be employed during a period of time when the intensity of the light is diminished or expected to diminish (e.g. overnight when it is dark, or during a cloudy period). The pressure in the reaction cell is preferably less than about 30 atmospheres, more preferably less than about 15 atmospheres, and most preferably less than about 5 atmospheres.

It may be possible to optionally employ a sol-gel process to produce catalysts in accordance with the present teachings. According to the teachings of the present invention, the process may use a CuAlO₂ catalyst produced by a calcination process (with or without any prior sol-gel synthesis of the catalyst), the reaction temperature may be greater than about 60° C., and the reaction zone may be free of organic compounds, where the hydrogen gas generation rate increases with temperature and the rate may be stable even after the catalyst is used for about 60 days.

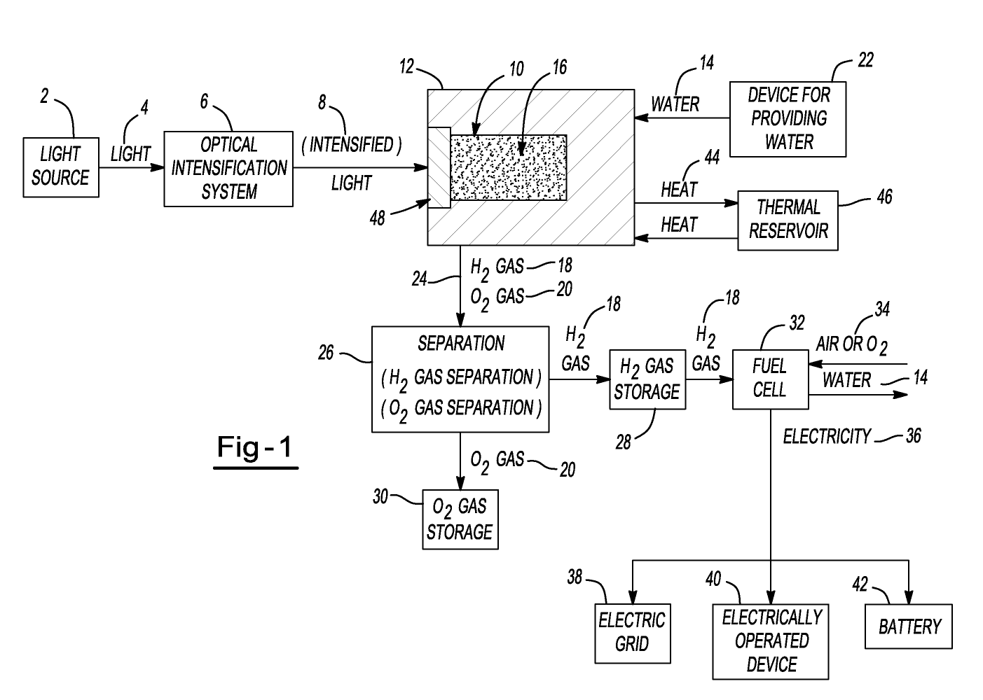

An example of a system for generating hydrogen gas is shown in FIG. 1. A light 2 source emits light 4, such light may include infrared light, visible light and ultraviolet light. The system for generating hydrogen gas may include an optical intensification system 6. The optical intensification system 6 may use mirrors, lenses, optical waveguides or other suitable optical arrangements or means to concentrate the light, i.e. to produce intensified light 8. The light 4 (or the intensified light 8), enters the reaction cell 10 (and particularly the reaction zone) of a reaction vessel 12. The cell 10 contains water 14 that is in contact with a catalyst 16. When the cell 10 is heated to a temperature greater than about 60° C., the light 4 (or the intensified light 8) provides the energy for the formation of hydrogen gas 18 from the water 14 molecules. The step of heating the cell 10 may include a step of converting infrared light into thermal energy. The system may also include a means 22 of providing water 14 into the 10 cell of the reaction vessel. Such means (e.g. a pump) may include circulating the water 14 in a liquid or a gas state. The system may also have a means 24 of removing the hydrogen gas 18, the oxygen gas 20, or both from the reaction vessel. After removing the hydrogen gas 18, the system may have one or more separators 26, for separating the hydrogen gas, the oxygen gas, or both. The hydrogen gas 18 may be transferred to a hydrogen storage container 28, and the oxygen gas, may be transferred to a oxygen storage container 30. The oxygen gas and the hydrogen gas may remain in the initial storage container until needed, or be moved to a secondary storage container, e.g. a storage tank in a vehicle. When needed, the hydrogen gas (e.g. the stored hydrogen gas) may be transferred to a fuel cell 32, which combines the hydrogen gas 18 with a gas containing oxygen 34 (from air, or any other source) to generate water 14 and produce electrical energy 36. The electricity can be provided to an 38 electric grid, used in an electrical device 40 (e.g. a motor, light, heater, pump, and the like), used for charging a battery 42, introduced into a storage device (e.g., a capacitor) or any combination thereof. The system may also include a heat transfer device 44 (e.g. a circulating fluid such as a heat pipe) for removing heat from the reaction vessel 12 and storing it in a thermal reservoir 46. The thermal reservoir may be used for generating hot water, or for heating a building. The thermal reservoir may also be used to provide heat back into the reaction vessel 12.

Optionally, the reaction cell 10 will not contain any galvanic cell, or elements that cooperate to form a galvanic cell. Thus corrosion and degradation of the catalyst, the reaction cell, or both, preferably is avoided.

The reaction vessel 12 preferably has one or more windows 48 or other panels that are at least partially optically transparent to allow the light to enter the cell 10 of the reaction vessel. Any type of window may be used. Preferably the window absorbs a low percentage of the light and transmits a large portion of the ultraviolet, visible and infared wavelengths of the solar spectrum. As an example, certain types of optically transparent materials (e.g., a transparent glass, or a transparent crystalline material such as quartz) may be employed.

According to the present invention, the means 22 of providing 14 water into the reaction vessel (e.g., a device including a pump, a regulator, a blower, or any combination thereof) and the means 24 of removing (e.g., a device including a separator, a membrane, a filter, or any combination thereof) the hydrogen gas 18 and the oxygen gas 20 may include a circulating system in which a gas that includes water vapor flows into the reaction zone 10 of the reaction vessel and a mixture of gases which include water vapor (e.g. unreacted water), hydrogen gas, and oxygen gas flows out of the chamber. Such a circulating system may use one or more steps to separate the hydrogen gas, the oxygen gas, and the water. These separation steps may employ one or more membranes which have selective permeability. The separated water may later be returned to the reaction vessel.

For photocatalytic generation of hydrogen from water, the vapor pressure of a water slurry mixture will increase with the reaction temperature. The increase in water vapor pressure with temperature is well known (see, e.g., Table I and FIG. 6, Chapter 19, of “Elements of Physics”, by G. Shortley and D. Williams, Prentice-Hall, Englewood Cliffs, N. J., 3^{rd} edition (1963)). For example, the water vapor pressure at 400° C.-500° C. exceeds about 220 atmospheres. Designing a safe reaction cell at such pressures poses engineering and economic challenges and performance is not necessarily predictable. For high temperature reactions, it may be desirable to use water that is only in the vapor state (and no liquid water) in the reaction cell. Such a reaction cell could be operated at low pressures. If the catalyst is present in a particulate form, the reaction cell could be a fluidized bed reactor, where the catalyst particles are suspended by a circulating gas. Reaction systems using water vapor in a fluidized bed reactor have been described by Zhou, J. J. and S. M. Lee, “Application of Bench-Scale Tests in Understanding a Commercial Fluidized-Bed Reactor Operation”, Ind. Eng. Chem. Res., vol. 43, pp. 5460-5465 (2004); House, P. K., Saberian, M., Briend, C. L., Berruti, F., and E. Chan, “Injection of a Liquid Spray into a Fluidized Bed: Particle-Liquid Mixing and Impact on fluid Coker Yields”, Ind. Eng. Chem. Res., vol 5663-5669 (2004); Tasaka, K., Furusawa, T., and A, Tsutsumi, “Steam Gasification of Cellulose with Cobalt Catalysts in a Fluidized Bed Reactor”, Energy and Fuels, vol. 21, pp. 590-595 (2007); all expressly incorporated herein by reference. An example of a fluidized bed reactor for decomposing methane gas to produce H₂ at 850° C. is described by Lee, K., Han, G., Yoon, K., and B. Lee, “Thermocatalytic hydrogen production from the methane in a fluidized bed with activated carbon catalyst”, Catalysis Today, vol. 93-95, pp. 81-86 (2004), incorporated herein by reference.

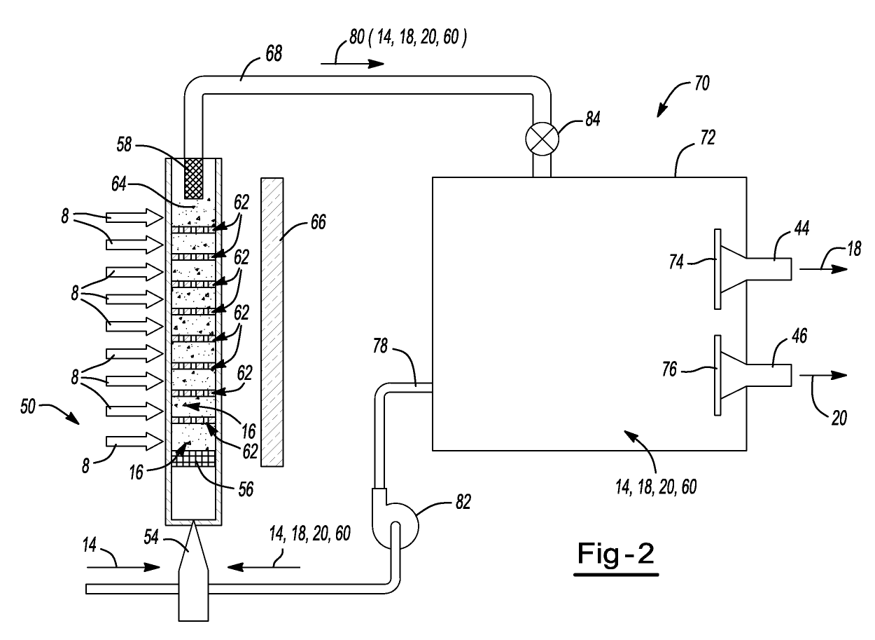

An example of a system containing a fluidized bed reactor is illustrated in FIG. 2. The reaction vessel 50 includes a fluidized bed reactor which contains the catalyst particles 16. A continuous flow of gas enters the reaction vessel through a nozzle 54, passes through a gas distributor 56, passes through the region containing the catalyst and exits through a filter 58. The filter allows for the exhaust of the gas from the reaction vessel while keeping the catalyst particles in the reaction vessel. Portoghese, F. et al., Chem. Engineering and Processing, vol. 46, pp. 924-34 (2007) describe a nozzle (see e.g. FIG. 2) which may be used in the present invention. The gas passing through the nozzle 54 into the fluidized bed contains the water 14 for the photocatalytic reaction. The gas may also contain hydrogen gas 18, oxygen gas 20, and other gases 60, such as an inert gas or air. For example, the gas entering the fluidized bed may contain recirculated gas that had been removed from the fluidized bed and thus contains residual water which did not react in the fluidized bed along with reaction products (i.e. hydrogen and oxygen gas) as well as any other gas which is in the system. The fluidized bed may also contain one or more screens 62 for containing the catalyst particles within various regions of the reactor and breaking up any bubbles. One or more of the walls of the fluidized bed 64 may be formed of glass or other transparent material, such that the light (or intensified light 8) may enter the reactor. It is also possible that most or all of the walls of the reactor vessel are transparent such that light may enter from many directions. For example, the reactor vessel 50 may be a glass cylinder which is surrounded by a cylindrical (e.g., cylindrical-section) solar reflector 66 which reflects light back into the reaction vessel. In such a case, the cylindrical solar reflector would have an opening to allow the incident solar radiation to enter. In another example, the reactor vessel may have one side which is transparent to allow the incident radiation to enter and the other sides may have a reflective interior surface which reflects the majority of the solar radiation. In yet another example, the majority of the solar radiation is captured by the gas molecules and catalyst particles after it first enters the reaction vessel and prior to reaching another wall of the reaction vessel. The material for the walls of the reaction vessel should also be chosen based on the reaction temperature. Examples of suitable glasses having softening temperatures from 620° C. to 1600° C. for use at the proposed reaction temperatures are given in Table 1, page 307, of “Concise Encyclopedia of Building and Construction Materials”, ed. by F. Moavenzadeh and R. W. Cahn, The MIT Press Ltd., 1990, ISBN:0080347282, incorporated herein by reference.

In the reaction vessel 50, the water 14 reacts with catalyst 16 and the light 8 to produce hydrogen gas 18, and oxygen gas 20 which results in an increase in pressure. The exhaust gas which contains unreacted water, oxygen, hydrogen, and optional additional gas molecules, exits the fluidized bed reactor through a filter and is transported in the exhaust tube 68 to a separator 70. The separator 70 may contain a reservoir 72 which may be connected to a hydrogen permeable membrane 74 and an oxygen permeable membrane 76 for removing the hydrogen gas and the oxygen gas. The separator may also be connected to a recirculation tube 78 which transports the gas back to the inlet nozzle of the fluidized bed reactor. As described before, additional water may be injected into the recirculating gas at the nozzle. The exhaust gas 80 and the exhaust tube 68 may be used to heat the nozzle 54, the recirculating tube 78, and the water entering the nozzle. The flow of the gases in the system may be controlled by one or more pumps 82, valves 84, or other flow regulators. According to the invention, the reaction vessel, the exhaust tube, the separator, and the recirculating tube may all be part of a chemically contained system except for the introduction of water molecules into the nozzle of the reactor and the discharge of the oxygen and hydrogen gases through the membranes.

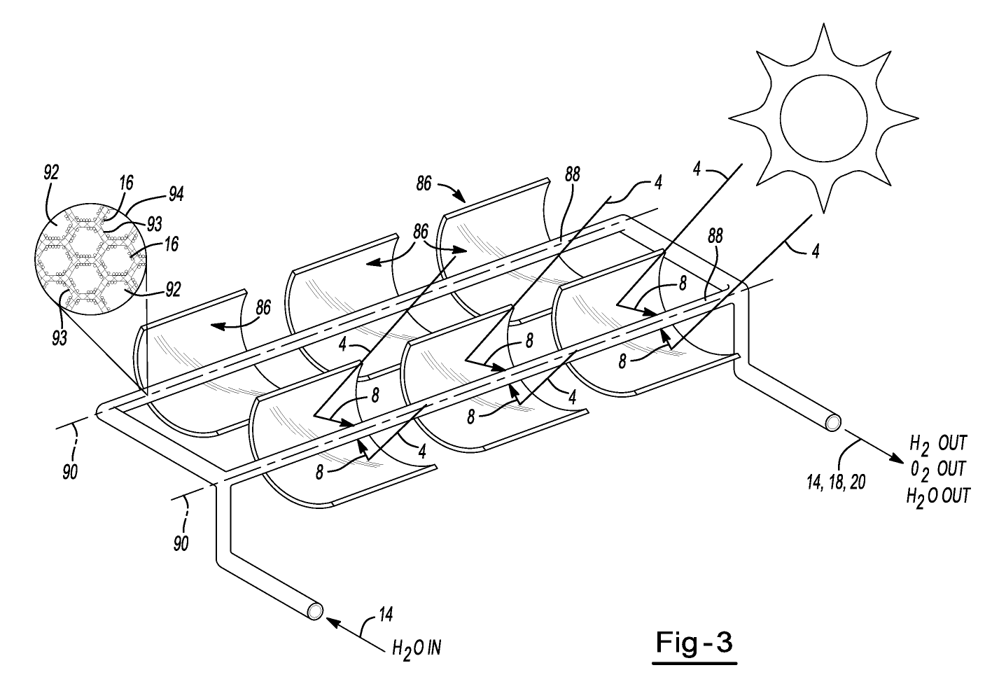

FIG. 3 illustrates a hydrogen gas generation system that includes one or more (e.g., an array of) optical intensification systems 86 (e.g., a solar concentrator, such as a parabolic solar concentrator). The optical intensification system reflects the sunlight 4 and directs the intensified light 8 at the reaction vessel 88 (e.g., a tubular reaction vessel). As illustrated in FIG. 3, the reaction vessel may be in the form of a tube or series of tubes with water 14 entering one end and a mixture of water, hydrogen 18, and oxygen 20, exiting at an opposite end. As illustrated, a row of parabolic solar concentrators may focus the light onto a common axis that is coaxial with the tubular reaction vessel 88. The optical intensification system may capable of being rotated about one or more axis 90, so that it tracks the sun and increases or even maximizes the intensity of the intensified light 8.

Any art known optical intensification system may be used. For example, solar intensification systems have been used to heat a molten salt to a temperature greater than about 500° C. In the present invention, the optical intensification system is employed to produce an energy form (i.e., hydrogen gas) that can be readily stored and/or transported.

Referring again to FIG. 3, the reaction vessel 88 may be a fixed bed reactor. Without limitation, a fixed bed could be in the form of a monolith 94, such as a monolith having a one, two, or more inner channels (i.e., openings) 92. For example, the fixed bed may have a plurality of channels 92 in which the water vapor may flow. Preferably, the reactor vessel is at least partially (or even entirely) made of a material that absorbs less than 15%, preferably less than 10%, more preferably less than 5% of the solar energy in the visible and ultraviolet wavelengths. For example, the reactor vessel may include, or be made of quartz (e.g., a quartz monolith). Quartz may be employed to absorb at least some of (e.g., at least 20%, or even at least 30%) of the infrared solar radiation, and convert it to thermal energy, thus increasing the temperature of the reaction vessel. FIG. 3 illustrates a cross-section of a monolith 94 (e.g., a quartz monolith) having a plurality of inner channels. The inner channels 92 are illustrated as having a hexagonal or honeycomb type cross-section. Any geometric shape (e.g., a rectangle, square, triangle, oval, circle, and the like) may be employed for the cross-section of the inner channels. The catalyst particles 16 may be distributed on the walls 93 of the monolith inner channels 92. Any art known method may be used to bond the catalyst particles to the inner walls of the reaction vessel (e.g., the walls of the monolith inner channels). For example, the catalyst particles may be distributed as a water slurry to the walls and bonded there by boiling off or otherwise removing the water. As another example, the catalyst may be applied to the monolith via a wash coat process.

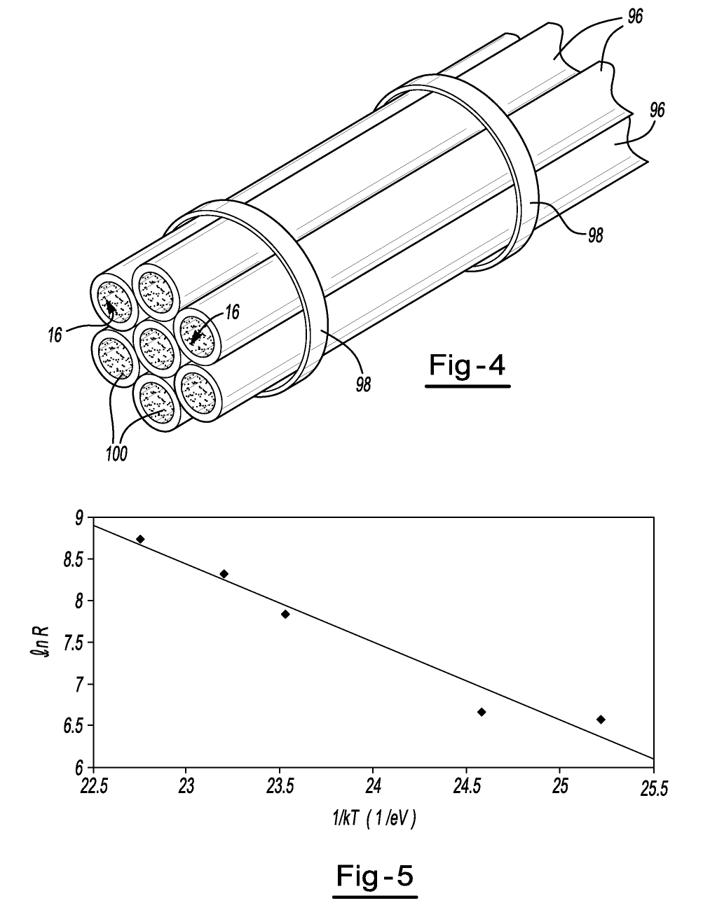

FIG. 4 illustrates a reaction vessel that consists of a bundle of tubes 96 (e.g., transparent or partially transparent tubes such as quartz tubes), The inside wall of at least some of (e.g., all of) the tubes may be coated with the catalyst 16, and the have an channel 100 so that the water may be transported through each tube. The bundle of tubes may be held together by one or more straps 98 or other binding device, or they may be inserted into a tube (e.g., a quartz tube) having a larger diameter. A reaction system may include a gasket (e.g., a quartz gasket or a metal gasket) to connect a plurality of tubes (e.g., a bundle of tubes) to a single water source, a gasket (e.g., a quartz gasket or a metal gasket) to connect a plurality of tubes to a discharge tube, or both. Such a gasket may also function as a means for supporting the tubes. The tubes preferably are supported or aligned so that they are located on a focal axis of the optical intensification system (e.g., the optical intensifier).

Electrical power may be produced by burning the hydrogen fuel to produce steam and then generating the electricity using steam Rankine cycle—generator set or by using a fuel cell to produce electricity. Steam power plants have efficiencies of about 30% and hydrogen fuel cells have efficiencies of about 50%. As an example, an average solar intensity of 250 W/m² over an 8 hour period may be converted into hydrogen fuel power at a conversion efficiency of about 40%. A field of about 225 acres could produce about 90 MW of hydrogen fuel power, which could be converted into 45 MW of electric power using a fuel cell. Thus, the 225 acres could power about 7,500 homes (assuming an average power requirement of 6 kW per home. For example, a hydrogen generation system may, produce enough hydrogen gas per acre of land to generate an average power of electricity (e.g., averaged over a year) greater than about 10 kW, preferably greater than about 50 kW, and most preferably greater than about 100 kW. Using the above assumptions, the daily hydrogen fuel production in about ¼ acre may be stored at about 1 atm within a spherical tank of about 7.6 m diameter.

The system for generating hydrogen may be mounted on a structure, (e.g. a roof of a building), or may be free standing (e.g. in a field). The system may be stationary, or may be on a mobile structure (e.g. a transportation vehicle, such as a boat, an automotive vehicle, and farming machinery). The mounting of the system may include a means for adjusting the positioning of the reaction zone, the optical intensification system, or both, such that the intensity of the light in the reaction zone is increased. For example, the optical intensification system may be adjusted so that it tracks the position of the sunlight. Such adjustments to the position of the optical intensification system may be made to accommodate seasonal or daily positioning of the sun. Preferably the adjustments are made frequently throughout the day.

In addition to generating hydrogen gas, the process desirably will also generate oxygen gas. Thus, the process may further comprise one or more steps of separating the oxygen gas from the hydrogen gas, separating the oxygen gas from the water, and storing the oxygen, or any combination thereof.

As mentioned above, the reaction vessel is heated (preferably using solar heat, e.g. infrared light).

The process of generating hydrogen gas may be characterized by the efficiency of converting the light energy (e.g. solar energy) into chemical energy (hydrogen gas molecules). The gaseous hydrogen molecules, when reacted with gaseous oxygen or air to from liquid water liberate 2.96 eV per water molecule. Thus, the amount of chemical energy can be determined by multiplying the number of hydrogen molecules generated by 2.96 eV. The energy of the solar light may be defined (at least for our purposes of defining an efficiency of a hydrogen gas generating system) as the amount of energy in the light having a wavelength from about 300 nm to about 800 nm. A typical solar intensity as measured at the Earth's surface, thus defined, is about 500 watts/m². The efficiency can be calculated as:

Efficiency=[(2.96eV×(1.602×10⁻¹⁹J/eV)−N/t]/(I_{L}×A_{L} (equation 3)

where t is the time in seconds, I_{L} is the intensity of the light (between 300 nm and 800 nm) in watts/m², A_{L} is the area of light entering the reaction chamber in m², N is the number of hydrogen molecules generated in time t, and 1 watt=1 J/s.

Practical processes may have an efficiency greater than about 1%. The efficiency is preferably greater than about 5%, More preferably greater than about 10% and most preferably greater than about 20%, (for example, the process may have an efficiency greater than about 30%). The photocalyst is preferably stable at the process conditions. For example the efficiency may decrease by less than 10% (compared to the initial efficiency) after the catalyst is used for photocatalytically generating hydrogen molecules at a temperature from about 100° to about 450° C. (e.g., at about 210° C.) for a cumulative time of about 200 hours, and more preferably for a cumulative time of about 1000 hours.

The rate of hydrogen gas generation, and thus the efficiency of the process, may increase exponentially with temperature as described earlier:

R=(v₀/2)β(I)N_{H}exp(−E_{D}/kT) (equation 1)

For steady-state heating of the reaction cell by solar radiation, a maximum temperature will be reached when the net heating from the solar radiation (i.e., that fraction of the solar radiation that is absorbed within the cell), is balanced by the cooling associated with H₂ and O₂ leaving the cell, along with cooling from conduction, convection, and radiation losses. Note from Eq. 1 that only the higher energy H atoms desorb from the catalyst surface, and these are the atoms which form H₂ and ultimately are to be separated from the cell by passing through a membrane. The cooling or energy loss associated with the separation of the H₂ and O₂ atoms from the cell includes a contribution from the thermal energy being removed, and a contribution from the energy required to convert the water to hydrogen gas and oxygen gas (the later is given by E[H₂(g)]+E[1/2O₂(g)]−E[H₂O)(I)]=2.96 eV). The cell energy loss from the separation of H₂ from the cell can be calculated by multiplying the H₂ generation rate by 2.96 eV. The value of E_{D} may be estimated by 1) measuring the hydrogen generation rate R at a given temperature, T, 2) estimating N_{H}, 3) combining these values with equation 1 to determine E_{D}. Alternatively, E_{D} may be estimated by measuring the hydrogen generation rate at multiple temperatures and plotting the In (R) against 1/kT (Arrhenius plot), where the slope of the line is a measure of −E_{D}.

Preferably, the catalyst used in the process will generally be stable, such that the rate of hydrogen generation at a given temperature and a given intensity of light does not significantly decline over time. For example it is desirable that the stability of the catalyst (or even the system) be characterized by a decay in the hydrogen gas generation rate of less than about 20% over a period of about 24 hours (or even about 60 days) with a light intensity of about 500 Watts/m² and a reaction temperature of about 250° C. In determining the stability of the catalyst or the system, it may be appropriate to employ substantially constant process conditions (e.g. one or any combination of reaction zone pressure, reaction temperature, catalyst concentration, suspension of the catalyst, water concentration, light source and light intensity, or the like).

Various aspects of the invention are directed at or employ an apparatus or device that may be used for photocatalytic generation of hydrogen gas. Examples of such an apparatus include a fixed bed reaction chamber (e.g., a monolithic structure having one, or more channels, such as a tube), such as one having photocatalyst particles attached to an interior surface and capable of transporting water (e.g., steam), and a fluidized-bed reaction chamber, such as one having photocatalyst particles that can be suspended by a fluid flow. Preferably a reaction chamber includes or consists substantially of one or more optically transparent materials.

The materials (e.g., photocatalysts) and processes described herein may use or be employed in a system for generating hydrogen molecules from sunlight and water in a reaction zone, comprising: i) an optical intensification system, wherein the optical intensification system increases the intensity of sunlight into the reaction zone by a factor greater than about 2; ii) water in the form of water vapor; and iii) nanoparticles of an inorganic photocatalyst compound in the reaction zone and in contact with water; wherein the reaction zone operates at a reaction temperature greater than about 140° C. and is exposed to the concentrated sunlight; the reaction zone is at least partially heated by converting sunlight into thermal energy; the reaction zone is free of an electrode; and wherein the system is further characterized by one of the following: (1) the nanoparticles are calcined nanoparticles; (2) the catalyst includes an element selected from Cu, Al, Ti, Ga, Cd, Zn, W, Fe, Sn, Si, or any combination thereof; or (3) both (1) and (2); such that a reaction occurs that generates hydrogen molecules from the water.

The system for generating hydrogen molecules may further be characterized by one or any combination of the following: the system further comprises a means (e.g. a pump, or a blower) for circulating the water (e.g., liquid water, steam, or both) through the reaction zone; the system further comprises a thermal reservoir for storing heat from the reaction zone, for providing heat to the reaction zone, or both; the system further comprises a separator for isolating the hydrogen molecules generated in the reaction zone; the system further comprises a separator for isolating the oxygen molecules that are generated in the reaction zone; the system further comprises a fuel cell or a steam Rankine generator set which converts the hydrogen molecules into water molecules, wherein the fuel cell or steam Rankine generator set produces electricity; the system further comprises a container for storing hydrogen molecules generated in the reaction zone; the system further comprises a means for positioning the reaction zone, an optical intensification system, or both, such that the intensity of the light in the reaction zone is increased; or the reaction zone is substantially free of sulfur containing compounds and any organic compounds.

### EXAMPLES

### Example 1 (EX. 1)

A catalyst sample of CuAlO₂ (catalyst sample 1) is prepared using a calcination process by first mixing and grinding powders of CuO having a purity of about 99.995% and Al₂O₃ having a purity of about 99.998% at a ratio of about 43.814 CuO to about 56.186 Al₂O₃ in a crucible. The mixture is then heated in air to a first calcination temperature of about 800° C. for a first calcination time of about 12 hours. Upon cooling, the mixture is again ground in a crucible. The sample is then heated in air to a second calcination temperature of 1000° C. for about 24 hours. Upon cooling, the mixture is again ground in a crucible. The sample is then heated in air to a third calcination temperature of about 1100° C. for about 24 hours. Upon cooling, the mixture is again ground in a crucible. The sample is then heated in air to a fourth calcination temperature of about 1150° C. for about 48 hours. Upon cooling, the mixture is again ground in a crucible. In a final heating step, the sample is then heated in air to a fifth calcination temperature of about 1160° C. for about 24 hours. After quenching to below room temperature, the catalyst is again ground.

Catalyst sample 1 is characterized by powder x-ray diffraction analysis and is representative of the crystal structure known for CuAlO₂. The BET surface area of catalyst sample 1 is about 22.7 m²/g, as measured by ASTM B-922. The density of catalyst sample 1 is about 5.33×10⁶ g/m³ as measured by helium pycnometer measurement. This catalyst is determined to have a mass weighted average particle diameter of about 49.4 nm.

A series of hydrogen generation studies is performed by placing 0.2 g of catalyst sample 1 in a stainless steel reaction vessel and adding 170 ml of water which has been filtered and deionized (the water is de-aerated with a resistivity of about 18M Ω). The water is not doped and thus is essentially free of any sulfur or organic compound. The catalyst and water mixture forms a slurry. The total gas volume in the cell is about 14.5 cm³. The vessel is sealed with copper gaskets. Sunlight is allowed to enter through a 38 mm diameter quartz (borosilicate) window.

The H₂ generation rate is determined after each run using a gas chromatograph with a pulsed discharge H₂ detector. The error in the measurement is about 100 ppm/hour. The rate of hydrogen gas generation is seen to increase with temperature. The rate of hydrogen gas generation is measured at different constant temperatures from about 300° K to about 510° K, and normalized by dividing by the actual intensity of the sunlight (in the 300-800 nm wavelength range, measured using an Atlas Xenocal sensor meter) and multiplying by the average intensity (500 W/m²) in this wavelength range. These normalized rates of hydrogen gas generation for EX. 1 are shown in TABLE 1. The same 0.2 gram specimen of catalyst sample 1 is used for all measurements. The measurement time at a given temperature varies from about 0.42 to about 4.03 hours.

The energy barrier for this photocatalyzed generation of hydrogen gas (e.g. the hydrogen desorption energy), E_{D}, is calculated using equation 1 using the total surface are of the catalyst particles to estimate N_{H}. Thus calculated, E_{D} is about 1.85 eV. When the cross-sectional area of the reaction chamber is used to estimate N_{H}, the calculated E_{D} is about 1.5 eV. An Arrhenius plot of the data for In(R) against 1/kT is shown in FIG. 5. A straight line fit of this plot has a correlation coefficient of 0.9798. When E_{D} is calculated from the slope of the line, where E_{D}=−d [In(R)]/d [(1/kT)], E_{D} is estimated to be about 0.94 eV. The pre-exponential is also obtained from the linear fit to the data, and it is found to be 11.3×10¹² ppm/hour. From this experimental pre-exponential, we can use Eq. 1 to estimate the number N_{H} of catalyst surface OH bonds participating in H desorption. Again, the pre-exponential is taken to be (v₀/2)β(I) N_{H}, where v₀ is the OH vibrational frequency (approximately 1.12×10¹⁴/sec). The lower bound to the catalyst surface area involved with the solar radiation is given by the area of the 38 mm diameter window. Combining this area with the experimental preexponential, it is found that β(I)N_{H} is at most of order 10⁻⁵ of a monolayer of catalyst surface OH bonds.

As such, one or more aspects of the invention may be characterized by a hydrogen gas generation rate per unit area of incident solar energy (in m²), R/A, where (R/A)>2×10¹²exp(−0.94 eV/kT), (where the units are ppm/hr/m², and T is in degrees Kelvin), preferably R/A>1×10¹³exp(−0.94 eV/kT), and more preferably R/A>6×10¹³exp(−0.94 eV/kT), and most preferably R/A>2×10¹⁴exp(−0.94 eV/kT).

The x-ray diffraction pattern of the catalyst is again measured after the hydrogen generation studies. There is no observable difference between expected the diffraction patterns of the catalyst measured before and after the hydrogen generation studies, and both match the diffraction pattern expected for CuAlO₂.

Comparative Example 1 (C1)—The normalized hydrogen generation rate of catalyst sample 1 is measured at 472° K in the absence of sunlight using the same conditions as in Example 1. The expected hydrogen generation rate is below 100 ppm/hour (i.e. below the error of the measurement), as seen in TABLE 1.

Comparative Example 2 (C2)— The normalized hydrogen gas generation rate of a catalyst sample prepared by a sol-gel method (Adolph Micheli sol-gel method). The reaction vessel is prepared similar to EX. 1 except precautions are not taken to prevent organic impurities from entering the vessels (e.g. organic material is employed for sealing the vessel). After exposing the cell to solar radiation at 360° K, the H₂ concentration in the cell gas volume is measured and the H₂ generation rate is expected to be below 100 ppm/hr. Repeat measurements are expected to indicate that the rate of hydrogen gas generation decreases by greater than 20% within the first 0.1 hour.

TABLE 1
Hydrogen generation rates

| | Units | EX. 1 | C1 | C2 |
|---|---|---|---|---|
| Time for the | hours | >15 | N/A | <0.1 |
| normalized | | | | |
| hydrogen | | | | |
| generation rate | | | | |
| to drop by 20% | | | | |
| Catalyst type | | Calcined | Calcined | CuAlO₂, not |
| | | CuAlO₂ | CuAlO₂, | calcined |
| Organic sealant | | No | no | yes |
| Window diameter | mm | 38 | 38 | 38 |
| Light source | | Sunlight, not | No light | Sunlight, not |
| | | concentrated | | concentrated |
| Average light | watts/m² | 500 | 0 | 500 |
| intensity | | | | |
| (wavelength range: | | | | |
| 300-800 nm) | | | | |
| Normalized | | | | |
| hydrogen | | | | |
| generation rate | | | | |
| at 300° K | ppm/hr | | | <100 |
| at 424° K | ppm/hr | <100 | | |
| at 460° K | ppm/hr | 715 | | |
| at 472° K | ppm/hr | 780 | <100 | |
| at 493° K | ppm/hr | 2541 | | |
| at 500° K | ppm/hr | 4115 | | |
| at 510° K | ppm/hr | 6244 | | |

### Example 2

The catalyst made according to Example 1 (catalyst sample 1) is placed in a reaction vessel. The reaction vessel is a fluidized bed reactor which uses a circulating gas that consists substantially of water vapor to disperse the catalyst particles.

TABLE II
Extrapolated Efficiencies

| Temperature (° C.) | Efficiency (%) |
|---|---|
| 400 | 10 |
| 430 | 20 |
| 449 | 30 |
| 463 | 40 |
| 475 | 50 |

The gas is injected into the reactor using a nozzle at the bottom of the reactor, passes through a distributor, enters the fluidized bed and then through a filter into the exhaust tube. The reaction vessel is exposed to intensified light having an intensity of about 5000 watts/m². The reaction vessel is heated to a temperature of about 400-500° C. and the maximum pressure in the fluidized bed is maintained below about 3-30 atmospheres. The efficiencies of converting solar energy to hydrogen fuel at temperatures from 400° C. to 500° C. may be calculated using the Arrhenius equation from data obtained at the lower temperatures (e.g., by extrapolating the Arrhenius plot of FIG. 5 to higher temperatures. The expected efficiencies of conversion of solar energy to hydrogen fuel energy at 400° C., 430° C., 449° C., 463° C., and 475° C. are given in Table II.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “‘x’ in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps. All references herein to elements or metals belonging to a certain Group refer to the Periodic Table of the Elements published and copyrighted by CRC Press, Inc., 1989. Any reference to the Group or Groups shall be to the Group or Groups as reflected in this Periodic Table of the Elements using the IUPAC system for numbering groups.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A process for generating hydrogen molecules from water comprising the steps of:
i) contacting the water with nanoparticles of an inorganic photocatalyst compound in a reaction zone of a reaction chamber;
ii) concentrating sunlight with an optical intensifier such that the intensity is increased by a factor greater than 2;
iii) heating the reaction zone to one or more reaction temperatures greater than 140° C. using the concentrated sunlight; and
iv) exposing water in the heated reaction zone and in the presence of the inorganic photocatalyst compound, while at the one or more reaction temperatures, to the concentrated sunlight so that a reaction occurs that generates hydrogen molecules from the water;
wherein the photocatalyst includes an element selected from Cu, Al, Ti, Ga, Cd, Zn, W, Fe, Sn, Si, or any combination thereof, the water is in the form of water vapor, the step of heating the reaction zone includes a step of converting the sun light into thermal energy, the reaction zone is free of any electrode for a photoelectrochemical process; and
wherein the photocatalyst is characterized by one of the following:
(1) the nanoparticles are calcined nanoparticles;
(2) the nanoparticles includes an element selected from Cu, Al, Ti, Ga, Cd, Zn, W, Fe, Sn, Si, or any combination thereof; or
(3) both (1) and (2).

2. The process for generating hydrogen molecules of claim 1 wherein the process is further characterized by the reaction zone is substantially free of sulfur containing compounds and any organic compounds.

3. The process for generating hydrogen molecules of claim 1, wherein the photocatalyst includes a compound selected from CuAlO₂, TiO₂, CuO, Cu₂O, NiO, GaAs, GaP, CdSe, ZnO, WO₃, Fe₂O₃, SnO₃, SiC, CuGaO₂, and CulnO₂ or any combination thereof.

4. The process for generating hydrogen molecules of claim 1, wherein the photocatalyst comprises nanoparticles having an average BET surface area greater than about 2 m²/g.

5. The process for generating hydrogen molecules of claim 1, wherein the photocatalyst comprises CuₓAl_{y}O_{z}, wherein x ranges from about 0.95 to about 1.05, y ranges from about 0.95 to about 1.05, x+y ranges from about 1.95 to about 2.05 and z ranges from about x+y−0.05 to about x+y+0.05.

6. The process for generating hydrogen molecules of claim 5, wherein the photocatalyst is prepared by a calcination process comprising a plurality of steps of heating a photocatalyst feedstock consisting essentially of either the CuAlO₂, or a mixture of CuO and Al2O3, to increasing temperatures;
wherein the plurality of steps includes
a step of heating the photocatalyst feedstock to a first calcination temperature from about 800° C. to about 1080° C. for a first calcination time of at least 2 hours, and a latter step of heating the photocatalyst feedstock to a calcination temperature of at least about 1155° C. for a calcination time of at least 2 hours.

7. The process for generating hydrogen molecules of claim 6, wherein the calcination process includes at least four steps of heating the photocatalyst feedstock to increasing temperatures.

8. The process for generating hydrogen molecules of claim 1, wherein the process for generating hydrogen includes one or more reaction temperatures from about 210° C. to about 550° C.

9. The process for generating hydrogen molecules of claim 1, wherein the process further comprises steps of separating the hydrogen and oxygen molecules from the water, and wherein the reaction zone has a pressure of from about 1.5 atmospheres to about 30 atmospheres.

10. The process for generating hydrogen molecules of claim 1, wherein the process further comprises
a step of removing heat; and a step of removing the hydrogen molecules from the reaction zone, wherein the step of removing the hydrogen molecules from the reaction vessel includes a step of continuously flowing water, liquid, vapor or both, into the reaction zone, through the reaction zone and out of the reaction zone.

11. The process for generating hydrogen molecules of claim 1, wherein the sunlight comprises ultraviolet light, visible light, and infrared light;
wherein the reaction requires the ultraviolet light, the visible light, or both; and
wherein the step of heating the water molecules includes a step of converting sunlight into thermal energy; and
the reaction zone is at least partially contained within a material that is transparent to solar radiation.

12. The process for generating hydrogen molecules of claim 1, wherein the reaction zone includes a fluidized bed containing the photocatalyst particles; wherein the photocatalyst particles are suspended by a continuous gas flow.

13. The process for generating hydrogen molecules of claim 1, wherein the reaction zone includes a fixed bed containing the photocatalyst particles.

14. The process for generating molecules for claim 13 wherein the fixed bed comprises a transparent monolith formed to contain open inner channels for gas flow through the monolith,
wherein the photocatalyst is attached to the inner channels,
wherein the material of the monolith is at least partially transparent to the ultra violet and visible parts of the solar spectrum; and wherein the monolith material at least partially absorbs the infrared part of the solar spectrum so that it is heated.

15. The process for generating hydrogen molecules of claim 1, wherein the process is further characterized by an efficiency of converting light energy into chemical energy which is greater than about 1%.

16. The process for generating hydrogen molecules of claim 1, wherein the process is further characterized by an efficiency of converting light energy into chemical energy which is greater than about 10%.

17. The process for generating hydrogen molecules of claim 4, wherein the process has an efficiency for converting solar energy into hydrogen molecules, wherein the efficiency decreases by less than 10% after the photocatalyst is used for photocatalytically generating hydrogen molecules at a temperature of about 210° C. for a cumulative time of about 200 hours.

18. An apparatus for photochemically generating hydrogen, wherein the apparatus comprises:
i) one or more reaction vessels, wherein each reaction vessel includes one or more channels for reacting the water with sunlight, wherein each channel has an entrance end and an exit end for flowing water, in the form of liquid, gas, or both, through the channel, and the reaction vessel is formed of a material that is substantially transparent to visible and ultraviolet light; and
ii) a photocatalyst attached to a surface located within an interior surface of the reaction vessel;
wherein the reaction vessel is free of any electrode for an electrochemical reaction.

19. An apparatus of claim 18, wherein the photocatalyst is attached to a surface of the reaction vessel.

20. An apparatus of claim 19, wherein the reaction vessel includes a monolithic structure having a plurality of channels, and a wall of the reaction vessel includes quartz.

21. An apparatus of claim 20, wherein the photocatalyst includes an element selected from Cu, Al, Ti, Ga, Cd, Zn, W, Fe, Sn, Si, or any combination thereof.

22. An apparatus of claim 21, wherein the photocatalyst comprises CuₓAl_{y}O_{z}, wherein x ranges from about 0.95 to about 1.05, y ranges from about 0.95 to about 1.05, x+y ranges from about 1.95 to about 2.05 and z ranges from about x+y−0.05 to about x+y+0.05.

23. An apparatus of claim 18, wherein the apparatus includes a plurality of reaction chambers and the photocatalyst includes an element selected from Cu, Al, Ti, Ga, Cd, Zn, W, Fe, Sn, Si, or any combination thereof.

24. An apparatus of claim 19, wherein the plurality of reaction chambers includes a bundle of quartz tubes and the photocatalyst comprises CuₓAl_{y}O_{z}, wherein x ranges from about 0.95 to about 1.05, y ranges from about 0.95 to about 1.05, x+y ranges from about 1.95 to about 2.05 and z ranges from about x+y−0.05 to about x+y+0.05.

25. A system for generating hydrogen molecules from sunlight and water in a reaction zone, comprising
i) a reaction chamber including a reaction zone;
ii) at least one optical intensifier that is in optical communication with the reaction zone and that heats the reaction zone to a temperature greater than 140° C.; and
iii) nanoparticles of an inorganic photocatalyst compound;
wherein the reaction chamber holds water and the nanoparticles, such that at least some of the nanoparticles contacts the water;
the optical intensifier increases the intensity of sunlight by a factor greater than about 2;
the reaction zone is free of any electrode for a photelectrochemical process; and
wherein the system is further characterized by one of the following:
(1) the nanoparticles are calcined nanoparticles;
(2) the photocatalyst includes an element selected from Cu, Al, Ti, Ga, Cd, Zn, W, Fe, Sn, Si, or any combination thereof; or
(3) both (1) and (2);
such that a reaction occurs that generates hydrogen molecules from the water.
